(19) United States
(12) Patent Application Publication
(10) Pub. No.: US 2006/0233052 A1
(43) Pub. Date: Oct. 19, 2006

(54) SHOCK-ABSORBER DEVICE FOR BALANCE PIVOT AND WATCH MOVEMENT FITTED WITH THE SAME

(75) Inventors: Alain Zaugg, Le Brassus (CH); Dominique Lechot, L'Orient (CH)

Correspondence Address: SUGHRUE MION, PLLC, 2100 PENNSYLVANIA AVENUE, N.W., SUITE 800, WASHINGTON, DC, 20037, US

(73) Assignee: MONTRES BREGUET SA

(21) Appl. No.: 11/277,800

(22) Filed: Mar. 29, 2006

(30) Foreign Application Priority Data
Mar. 31, 2005 (EP) 05007046.5
Apr. 21, 2005 (EP) 05103261.3

(51) Int. Cl. G04B 19/00

(52) U.S. Cl. 368/76

(57) ABSTRACT

The invention proposes a shock-absorber device for the balance pivot of a watch movement comprising a jewelled setting which is held resiliently by a spring in a complementary housing arranged on a fixed support and which is fitted with a jewel forming an endstone, of the type wherein the spring is formed by a metal strip which is fixed on the support so as to overhang, which extends in a radial plane in relation to the pivot, and which forms an arm including a securing end, and an abutting end abutting axially against the endstone so as to hold the jewelled setting axially in its housing, characterized in that the arm includes, from the securing end, a section generally rectilinear and parallel to a radial direction, relative to the axis of the pivot, a resilient section in the form of an annular sector and an abutting sector which extends generally along a diametral direction substantially perpendicular to the rectilinear sector so as to form the abutting end. The invention also proposes a watch movement fitted with a device of this type.

This application claims priority from European Patent Application No 05007046.5 filed Mar. 31, 2005 and No. 05103261.3 filed Apr. 21, 2005, the entire disclosure of which is incorporated herein by reference

The invention concerns a shock-absorber device for a balance pivot of a watch movement.

The invention concerns more specifically a shock-absorber device for a watch movement, in particular for a balance pivot, comprising a jewelled setting which is resiliently held by a spring in a complementary housing arranged on a fixed support and which is fitted with a jewel forming an endstone, of the type wherein the spring is formed by a metal strip which is fixed overhanging the support, which extends in a radial plane in relation to the pivot, and which forms an arm including a securing end, and an abutting end that abuts axially against the endstone so as to hold the jewelled setting axially in its housing.

This type of shock-absorber device is disclosed and shown particularly in CH Patent No. 237,999. In this Patent, the securing end of the spring arm is distant from the endstone and a space has to be arranged between the top surface of the bar and the intermediate section of the arm, between the abutting end and the securing end, to allow resilient bending of the arm about a substantially transverse axis.

Development of this type of shock-absorber device raises difficulties since it is difficult to control accurately the intensity of the return force exerted by the spring on the endstone, because of the relatively large moment arm between the abutting end and the securing end. Moreover, the intensity of the return force of the spring is limited, and when one wishes to alter the features of the return force, the spring arm has to be altered as a whole over its entire length.

It is an object of the present invention to overcome these drawbacks.

The invention therefore proposes a shock-absorber device of the type previously described, characterized in that the arm includes, from the securing end, a section generally rectilinear and parallel to a radial direction, relative to the pivot axis, a resilient section in the shape of an annular sector, and an abutting sector which extends overall along a diametral direction substantially perpendicular to the rectilinear section so as to form the abutting end.

The invention also proposes a watch movement fitted with this device.

Other features and advantages of the present invention will appear more clearly upon reading the following detailed description, made with reference to the annexed drawings, given by way of non-limiting example and in which:

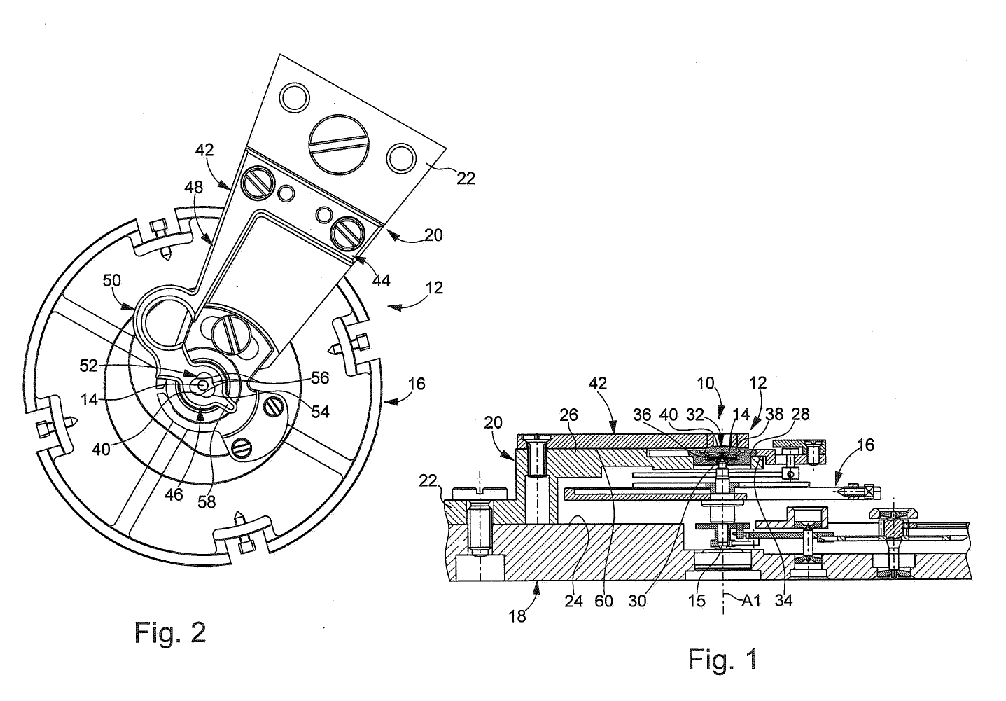

FIG. 1 is an axial cross-section which shows schematically a part of a watch movement fitted with a shock-absorber device in accordance with the teaching of the invention;

FIG. 2 is a top view that shows schematically the shock-absorber device of FIG. 1.

FIGS. 1 and 2 partially show a watch movement 10 fitted with a shock-absorber device 2 for the pivot 14 of a balance 16 made in accordance with the teaching of the invention.

Watch movement 10 includes in particular a plate 18 to which is fixed a support 20 for a balance 16, which will be designated the bar or bridge 20, and which is sometimes called the “balance-cock”. Balance 16 is rotatably mounted about its axis A1 between bar 20 and plate 18 by means of a bottom pivot 15 and a top pivot 14.

Bar 20 comprises a transverse securing plate 22 which is screwed onto top face 24 of plate 18 and a transverse support plate 26 which overhangs from securing plate 22 delimiting, with top face 24 of plate 18, an axial space for the passage of balance 16.

Support plate 26 includes a housing 28 provided with an aperture 30 which receives a jewelled setting 32 forming a bearing for top pivot 14 of balance 16. Housing 28 is arranged herein an intermediate part 34 secured to support plate 26.

Housing 28 is stepped axially and it comprises, for example, truncated concave shoulders which are complementary to truncated convex surfaces made on the peripheral walls of setting 32.

Setting 32 is fitted with a bottom holed jewel 36 which is provided for receiving the top end section of top pivot 14 of balance 16, and a top jewel forming endstone 38. Endstone 38 comprises here a slightly raised surface 40.

Setting 32 is resiliently held in its housing 28 by means of a spring 42. Spring 42 is formed by a flat metal strip which fixed so as to overhang, here over support plate 26 of bar 20. Spring 42 extends in a radial plane, in relation to pivot 14, and it forms an arm 42 comprising a securing end 44 and an abutting end 46. Abutting end 46 abuts axially against raised surface 40 of endstone 38 so as to hold setting 32 axially in its housing 28 in a rest position.

According to the teaching of the invention, arm 42 includes, from securing end 44, a section 48 generally rectilinear and parallel to a radial direction, relative to axis A1 of pivot 14, a resilient section in the shape of an annular section 50, and an abutting section 46 which extends generally along a diametral direction substantially perpendicular to rectilinear section 48 so as to form abutting end 46.

Annular sector 50 works in torsion, generally around an axis parallel to the rectilinear section 48, which ensure optimum control of the return force that is applied to setting 32. This return force can be optimised, for example, by choosing a suitable radial thickness of annular section 50, without altering the axial thickness.

According to an advantageous embodiment, abutting section 46 extends one end of annular sector 50 and it includes a hole 52, which is coaxial to axis A1 of pivot 14 and which includes a curved peripheral edge 54, in a radial plane, defining at least three abutment points 56 in contact with raised surface 40 of endstone 38.

Preferably, abutting section 46 is extended diametrally, on the opposite side to annular sector 50, by a tongue 58.

Annular sector 50 extends over an angle substantially greater than or equal to one hundred and eighty degrees, for example of the order of two hundred and seventy degrees.

Advantageously, the rectilinear section 48 extends generally along a tangent direction to the outer peripheral edge of endstone 38.

Annular sector 50 is offset laterally in relation to rectilinear section 48, on the opposite side to pivot 14.

According to the embodiment shown, securing end 44 is formed by a generally rectangular radial plate which forms a right angle with rectilinear section 48.

Preferably, the bottom radial surface 60 of rectilinear section 48 abuts axially against the opposite radial surface of bar 20. This arrangement ensures that arm 42 abuts properly on bar 20 such that annular sector 50 works optimally in torsion.

According to the embodiment that has just been described, shock-absorber device 12 according to the invention was arranged on the side of bar 20. According to an alternative embodiment (not shown), shock-absorber device 12 could be arranged on the side of plate 18 to be associated with bottom pivot 15.

What is claimed is:

1. A shock-absorber device for a watch movement, particularly for the pivot of a balance, including a jewelled setting which is held resiliently by a spring in a complementary housing arranged on a fixed support and which is fitted with a jewel forming an endstone, of the type wherein the spring is formed by a metal strip which is fixed on the support so as to overhang, which extends in a radial plane in relation to the pivot, and which forms an arm including a securing end, and an abutting end abutting axially against the endstone so as to hold the jewelled setting axially in its housing,
wherein the arm includes, from the securing end, a section generally rectilinear and parallel to a radial direction, relative to the axis of the pivot, a resilient section in the form of an annular sector, and an abutting sector which extends generally along a diametral direction substantially perpendicular to the rectilinear sector so as to form the abutting end.

2. The shock-absorber device according to claim 1, wherein the abutting section extends one end of the annular sector.

3. The shock-absorber device according to claim 1, wherein the abutting section includes a hole which is coaxial to the axis of the pivot and which includes a curved rectilinear edge, in a radial plane, defining at least three points of abutment, in contact with the endstone.

4. The shock-absorber device according to claim 1, wherein the abutting section is extended diametrally, on the opposite side to the annular sector, by a tongue.

5. The shock-absorber device according to claim 1, wherein the annular sector extends over an angle greater than one hundred and eighty degrees.

6. The shock-absorber device according to claim 1, wherein the rectilinear section extends generally along a tangent direction to the outer peripheral edge of the endstone.

7. The shock-absorber device according to claim 6, wherein the annular sector is offset laterally in relation to the rectilinear section, on the opposite side to the pivot.

8. The shock-absorber device according to claim 1, wherein the securing end is formed by a rectangular radial plate whose longitudinal direction is substantially perpendicular to the rectilinear section, and wherein the rectilinear section extends from a longitudinal end of the plate.

9. The shock-absorber device according to claim 1, wherein the bottom radial surface of the rectilinear section abuts axially against the opposite radial surface of the bar.

10. A watch movement which includes a shock-absorber device according to claim 1.
